(19) United States
(12) Patent Application Publication
(10) Pub. No.: US 2006/0090140 A1
(43) Pub. Date: Apr. 27, 2006

(54) Computer executable message system and method thereof

(76) Inventor: Chung-Chih Tung, Taipei (TW)

Correspondence Address: HARNESS, DICKEY & PIERCE, P.L.C., P.O. BOX 8910, RESTON, VA, 20195, US

(21) Appl. No.: 10/965,877

(22) Filed: Oct. 18, 2004

(51) Int. Cl. G06F 3/00; G06F 17/00; G06F 9/00

(52) U.S. Cl. 715/764; 715/867; 715/808

(57) ABSTRACT

A computer executable message system and the method thereof are disclosed. During the operation of a computer screen saver program, a received trigger is checked to determine whether to generate a message input window or to display the entered message. This allows the user to obtain messages left by a visitor.

### BACKGROUND OF THE INVENTION

1. Field of Invention

The invention relates to a computer executable message system and the method thereof. More particularly, the invention relates to a system and the corresponding method that use a screen saver program to check a trigger signal, thereby determining whether to receive or display a message.

2. Related Art

In the usual office operation mechanism, a person may have to temporarily leave his or her seat for some reason. If his or her supervisors, colleagues, friends, or family happen to be looking for him or her at the time, they usually leave a message so that the person can know who has just visited once returning to the seat.

Since computers have become an indispensable tool in offices to replace traditional word processing environment comprised of pens and paper. To reduce the aging of computer screens and the company cost, screen saver programs are often used to protect the screens when the computers are temporarily not in use.

Although computerized offices can enhance work efficiency, the traditional way of leaving a message on the desk of a person is still inconvenient because the message may be ignored, removed, or read by other people, resulting in unnecessary disturbance or troubles. One thus sees that the traditional way of leaving messages has a problem in the security and privacy.

### SUMMARY OF THE INVENTION

In view of the foregoing, the invention provides a computer executable message system and the method thereof. A trigger signal is used to determine whether to provide a message input window or to display the entered message.

An objective of the invention is to provide a computer executable message system and the method thereof, using which people can use the computer to leave a message for the computer user.

To achieve the above-mentioned objective, the disclosed system includes a message database, a determination and reception unit, a recording and extracting module, and a screen saver program database.

The disclosed method mainly includes two parts: one being the visitor leaving a message and the other being the computer user reading the message. The first part includes the following steps. The system receives any trigger signal from a visitor to provide a message input window. After the visitor enters the message, the system receives the visitor's message and stores it in the message database. The second part includes the following steps. The computer user sends out an exclusive signal. After receiving the exclusive signal, the system reads out the message stored in the message database. Afterwards, the system displays the message to the computer user.

In summary, we see that the invention can solve the problems existing in the prior art and achieve the following effects:
1. The message for the computer user can be correctly and surely transmitted.
2. The resources in the computer will not be readily obtained by unauthorized people.

### BRIEF DESCRIPTION OF THE DRAWINGS

The invention will become more fully understood from the detailed description given hereinbelow illustration only, and thus are not limitative of the present invention, and wherein:

FIG. 1 shows a structure of the disclosed message system;

FIG. 2-A is a flowchart of how a visitor can leave a message; and

FIG. 2-B is a flowchart of how a computer user can read the stored messages.

### DETAILED DESCRIPTION OF THE INVENTION

The disclosed computer executable message system and method uses a trigger signal to determine whether to provide a message input window or to display an entered message. Therefore, the invention pertains to a system and a method that use a computer to transmit a message for the computer user.

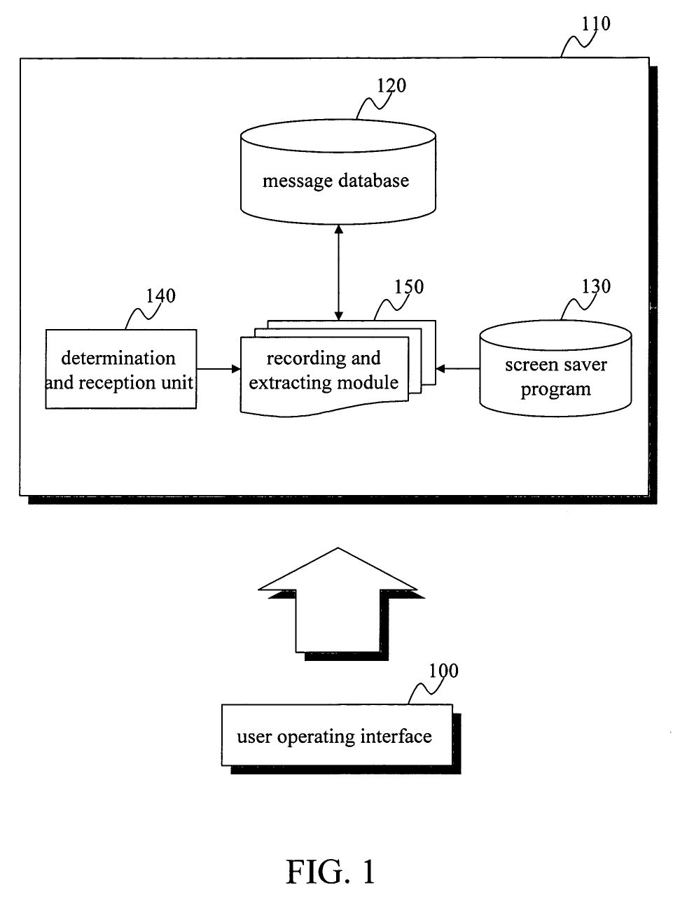

As shown in FIG. 1, the disclosed message system 110 includes a message database 120, a screen saver program 130, a determination and reception unit 140, and a recording and extracting module 150.

The computer user or visitor can perform settings or operations on the message system 110 through a user operating interface (UOI) 100. The functions of each part in the message 110 are described as follows.

The message database 120 stores and provides the message left by the visitor. The screen saver program database 130 stores and provides screen saver programs. The determination and reception unit 140 receives a trigger signal, a message, or a selection command and performs a corresponding determination procedure. The recording and extracting module 150 saves and reads the message in the message database 120. It further extracts a screen saver program from the screen saver program database 130.

Before the operation of the system, the computer user has to perform settings and operations on the message system 110 via the UOI 100. When the determination and reception unit 140 receives the screen saver program set by the user, the recording and extracting module 150 immediately extracts out the screen saver program from the screen saver program database 130 to use.

If there is a visitor using the computer, the determination and reception unit 140 of the message system 110 receives a trigger signal and performs a determination procedure. A command is transmitted accordingly to the recording and extracting module 150. The recording and extracting module 150 then provides a message input window or extracts a list of messages from the message database 130 for the computer user to select.

The trigger signal mentioned above can be sent out by hitting a key, moving a mouse, or clicking a mouse button. Through the system settings, one can set a special key (e.g. F1) or a special key hitting (e.g. hitting F1 five times or clicking the right button of a mouse three times) to return to the operating system (OS).

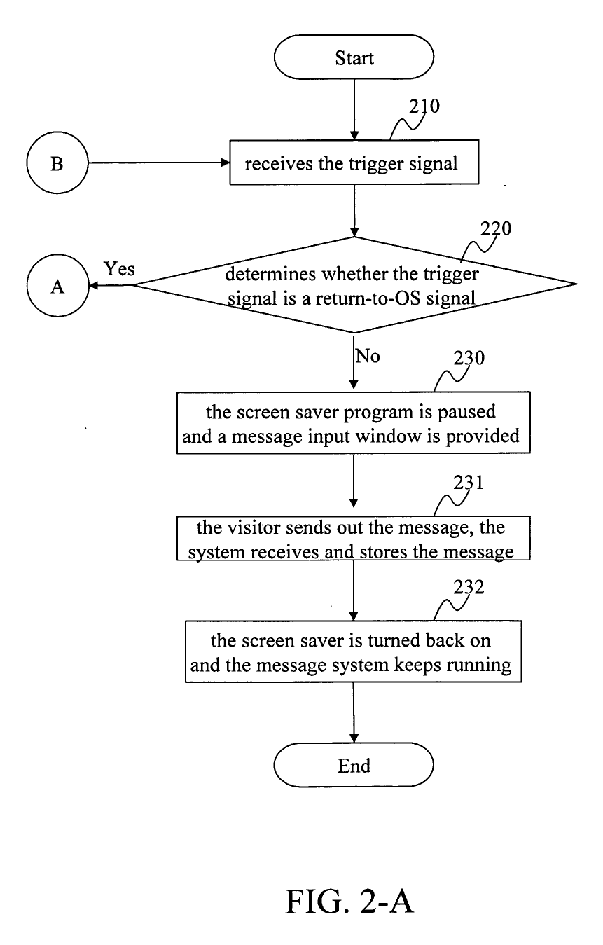

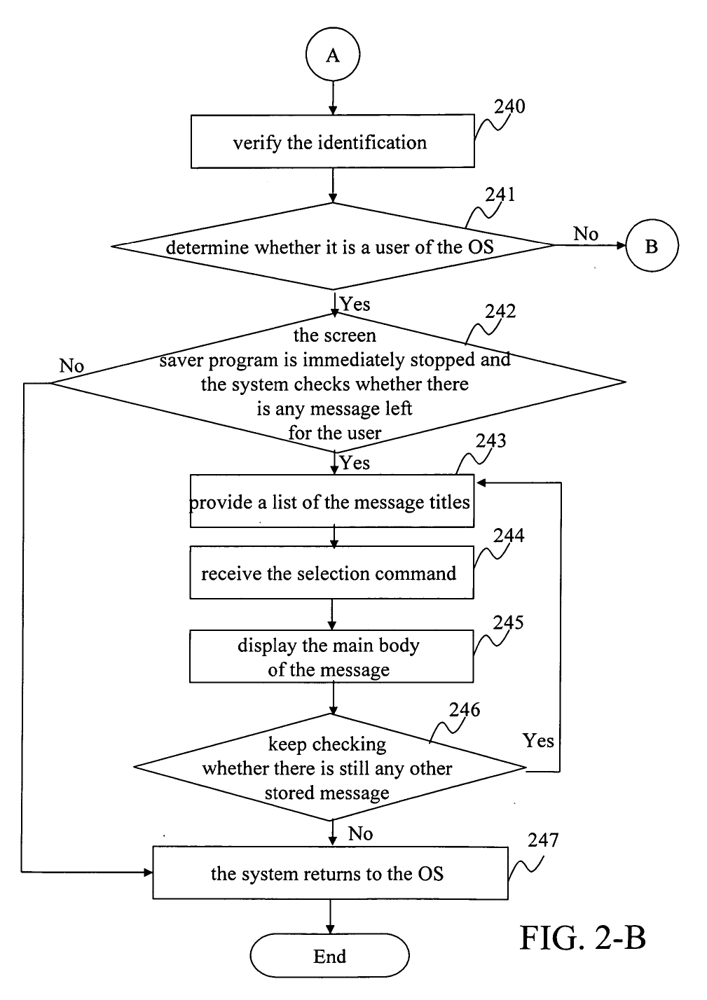

After describing the system operation structure of the invention, we use FIG. 2-A and FIG. 2-B to explain the disclosed method.

As shown in FIG. 2-A, the message system immediately extracts a screen saver program from the screen saver program database 130 to use after the computer user starts the message system. When the computer user or a visitor hits any key on the keyboard, clicks a button on the mouse, or moves the mouse, a trigger signal is sent out to the system. After the system receives the trigger signal (step 210), it determines whether the trigger signal is a return-to-OS signal (step 220). If so, then the procedure continues to FIG. 2-B to verify the identification (step 240). Otherwise, the screen saver program is paused and a message input window is provided (step 230) for the visitor to enter a message. After the visitor sends out the message, the system receives and stores the message (step 231). Afterwards, the screen saver is turned back on and the message system keeps running (step 232).

As shown in FIG. 2-B, an identification verification procedure is performed when the trigger signal is a return-to-OS signal (step 240). The user is asked to enter the user account name and password for verification. The user account name and password are used to determine whether it is a user of the OS (step 241). Once the user passes the verification procedure, the screen saver program is immediately stopped and the system checks whether there is any message left for the user (step 242). If no message exists in the message database 120, the system returns to the OS (step 247) and stops the operation of the message system. If there is a message in the message database 120, the system provides a list of the message titles (step 243) for the user to select. Once the computer selects a message title, the system receives the selection command (step 244) and displays the main body of the message (step 245) for the user. After the computer user shuts down the message display window, the system keeps checking whether there is still any other stored message (step 246). If so, then the system returns to step 243; otherwise, the system returns to the OS (step 247). The message system stops running, and the user resumes the normal computer operation.

Certain variations would be apparent to those skilled in the art, which variations are considered within the spirit and scope of the claimed invention.

What is claimed is:

1. A computer executable message system, along with a screen saver program, providing the functions of message input and display, comprising:
a message database, which stores a plurality of messages;
a screen saver program database, which stores a plurality of screen saver programs;
a determination and reception unit, which receives a trigger, the message, and a selection command to perform a determination procedure accordingly; and
a recording and extracting module, which stores the message in the message database, extracts the message out from the message database, and extracts the screen saver program from the screen saver program database.

2. The computer executable message system of claim 1, wherein the trigger signal is sent by hitting a key on the keyboard.

3. The computer executable message system of claim 1, wherein the trigger signal is sent by operating a mouse.

4. The computer executable message system of claim 1, wherein the trigger signal includes a return-to-OS signal.

5. The computer executable message system of claim 4, wherein the return-to-OS signal is sent via a key on the keyboard.

6. The computer executable message system of claim 4, wherein the return-to-OS signal is sent by hitting a key on the keyboard a specific times.

7. The computer executable message system of claim 4, wherein the return-to-OS signal is sent by clicking a mouse button a specific times.

8. The computer executable message system of claim 1, wherein the determination and reception unit further determines the identification of a user.

9. A computer executable message method, along with a screen saver program, for providing the functions of message input and display, comprising the steps of:
receiving a trigger signal;
determining that the trigger signal is not a return-to-OS signal;
pausing the operation of the screen saver program and providing a message input window; and
receiving a message and stores the message.

10. The computer executable message method of claim 9, wherein the trigger signal is sent by hitting a key on the keyboard.

11. The computer executable message method of claim 9, wherein the trigger signal is sent by operating a mouse.

12. A computer executable message method, along with a screen saver program, for providing the functions of message input and display, comprising the steps of:
receiving a trigger signal;
determining that the trigger signal is a return-to-OS signal;
pausing the operation of the screen saver program and providing a list of message titles; and
receiving a selection command and displaying a message accordingly.

13. The computer executable message method of claim 12, further comprising the step of identification verification using the entered user account name and password.

14. The computer executable message method of claim 12, wherein the trigger signal is sent by hitting a key on the keyboard.

15. The computer executable message method of claim 12, wherein the trigger signal is sent by hitting a key on the keyboard a specific times.

16. The computer executable message method of claim 12, wherein the trigger signal is sent by clicking a mouse button a specific times.
